(19) United States
(12) Patent Application Publication
(10) Pub. No.: US 2010/0110043 A1
(43) Pub. Date: May 6, 2010

(54) STYLUS AND ELECTRONIC DEVICE USING THE SAME

(75) Inventor: Pen-Uei Lu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/471,555

(22) Filed: May 26, 2009

(30) Foreign Application Priority Data
Oct. 30, 2008 (CN) 200810305311.3

(51) Int. Cl. G06F 3/033

(52) U.S. Cl. 345/179

(57) ABSTRACT

A stylus includes a shaft and a ring connected to the shaft. The shaft is at a periphery of the ring. The ring is configured to sleeve on a finger of a user. The stylus can be steadily sleeved on the finger and convenient for using. Further provide is an electronic device using the stylus.

### BACKGROUND

1. Technical Field

The present disclosure generally relates to touch screen technology, and more particularly to a stylus and an electronic device using the same.

2. Description of Related Art

With the development of communication technology, more and more electronic devices, such as mobile phone and PDA (personal digital assistant), with touch panels, are widely used. Styluses are frequently used with these electronic devices.

A stylus which with a fingerstall includes a main body and a nib formed at an end of the main body. The main body has a cylindrical sleeve and a pyramidal sleeve aligned coaxial with the cylindrical sleeve. The cylindrical sleeve receives a finger of a user and the pyramidal sleeve contacts a touch panel. A sidewall of the main body defines a gap along an axis thereof which can accommodate different sizes of finger. A protrusion with a hole is further formed on the sidewall of the main body, accepting a line or a cable therethrough providing attachment to the main body.

In use, the main body of the stylus is sleeved on the finger, allowing single-digit of characters on the panel, wherein the stylus need not be held in conventional manner.

However, when the main body of the stylus is sleeved on the finger, the inner-wall of the main body may abut the end of the user's finger, and the stylus may not be securely seated on the finger, impairing proper function.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an assembled, isometric view of an embodiment of a stylus and an embodiment of an electronic device applying the stylus.

FIG. 2 is an exploded, isometric view of the electronic device of FIG. 1.

### DETAILED DESCRIPTION

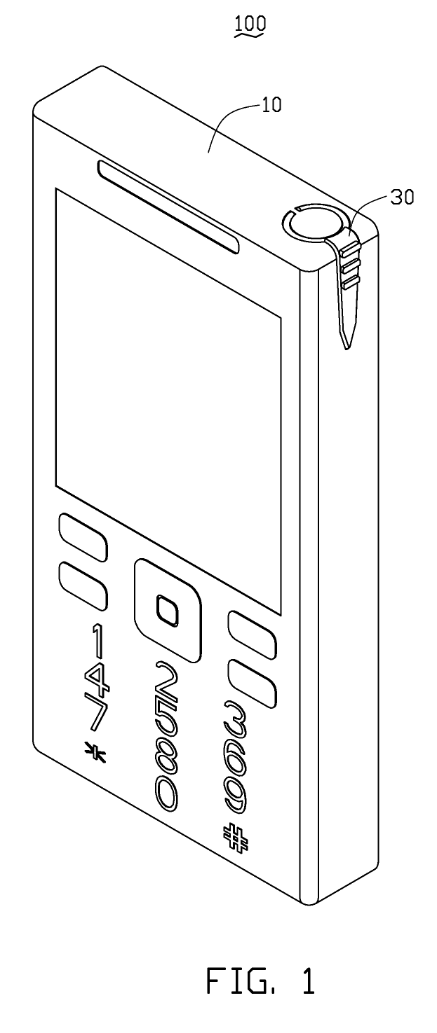

The present stylus may be used with any electronic device with a touch panel, such as mobile phone, PDA, and others. Referring to FIG. 1, an embodiment of an electronic device 100 includes a main body 10 and a stylus 30 mounted thereon.

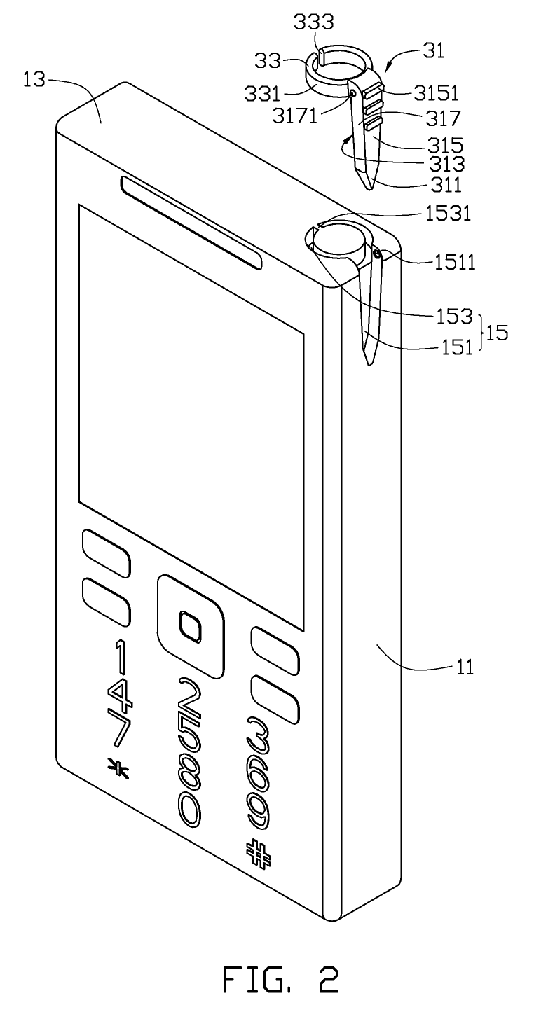

Also referring to FIG. 2, the main body 10 has a first sidewall 11 and a second sidewall 13 adjacent and perpendicular to each other. The main body 10 defines a receiving portion 15 for the stylus 30. The receiving portion 15 includes a first groove 151 communicating with a second groove 153. The first sidewall 11 defines the first groove 151, and the second sidewall 13 defines the second groove 153. The second groove 153 is annular. Two sidewalls (not labeled) of the first groove 151 define a depression 1511 adjacent to the second groove 153 on each of the two sidewalls. A clapboard 1531 is formed in the second groove 153.

The stylus 30 includes a shaft 31 and a ring 33 connected to an end thereof. The shaft 31 is at a periphery of the ring 33. That is, most of the ring 33 or even the entire ring 33 is on the same side of the shaft 31. In the illustrated embodiment, the shaft 31 extends approximately parallel to the axis of the ring 33. Here, the stylus 30 is plastic.

The shaft 31 includes a nib 311 on an end thereof away from the ring 33. The nib 311 is substantially tapered such that the contact area thereof allows precise data input in limited space. The shaft 31 includes a first side-surface 313, a second side-surface 315 opposite thereto the first side-surface 313, and two third side-surfaces 317 opposite to each other. The second side-surface 315 forms a friction portion 3151, and in the illustrated embodiment, the friction portion 3151 is a plurality of protrusions protruding from the second side-surface 315 to enhance the friction between the second side-surface 315 and a finger (not shown) of a user. In the illustrated embodiment, a locating protrusion 3171 is formed on each of the third side-surfaces 317 to engage the depression. Alternatively, the location protrusion 3171 can be formed on one of the third side-surfaces 317. Correspondingly, one of the two sidewalls of the first groove 151 forms a locating protrusion.

The ring 33 has an outer surface 331 and defines an opening 333 away from the shaft 31. The outer surface 331 connects with the first side-surface 313 of the shaft 31. The opening 333 is away from a junction of the ring 33 and the shaft 31 so as to avoid weakening connection therebetween. The diameter of the ring 33 is adjustable, to accommodate different sizes of finger.

In the electronic device 100, the stylus 30 is received in receiving portion 15 of the main body 10, at which time the inside wall (not labeled) of the first groove 151 resists the third side-surface 317 of the shaft 31 to deform the shaft 31, and the locating protrusion 3171 engages the depression 1511 of the receiving portion 15, thus the stylus 30 is steadily secured to the main body 10. The ring 33 is received in the second groove 153, and the clapboard 1531 in the second groove 153 engages the opening 333 of the ring 33 to prevent the ring 33 from moving.

In use, the user just needs to push the shaft 31 out from the second groove 153 by pushing the friction portion 3151 of the shaft 31, and draw the shaft 31 out from the first groove 151 by drawing the ring 33, then sleeve the ring 33 on the appropriate position of a finger. The user is able to manipulate the stylus 30 just by one finger.

In the electronic device 100, the shaft 31 extends approximately parallel to the axis of the ring 33, so when the ring 33 is placed on the finger, the shaft 31 extends approximately parallel to the finger. The opening 333 of the ring 33 allows the stylus 30 to be usable with different thickness fingers, providing secure grip thereof. Being made of plastic, the stylus 30 is of low cost.

In alternative embodiments, the location protrusion 3171 and the depression 1511 may be positioned in other places, for example, the location protrusion 3171 may be formed on the outer surface 331 of the ring 33, and the depression 1511 may be defined in the inner surface (not labeled) of the second groove 153. The location protrusion 3171 and the depression 1511 may be omitted. The opening 333 of the ring 33 and the clapboard 1531 in the second groove 153 may be omitted. Instead, for example, the ring 33 is made of other material with higher elasticity. The inner diameter of the ring 33 can be changed according to the size of finger used. The shaft 31 may not extend parallel to the axis of the ring 33, and may be perpendicular thereto. Correspondingly, the main body 10 may define the first groove 151 and the second groove 153 on one sidewall to receive the stylus 30.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1 A stylus, comprising:
a shaft; and
a ring connected to the shaft;
wherein the shaft is at a periphery of the ring.

2. The stylus of the claim 1, wherein the ring defines an opening.

3. The stylus of the claim 2, wherein the ring has an outer surface to which the shaft is connected away from the opening.

4. The stylus of the claim 3, wherein the shaft forms a nib at an end thereof away from the end connected to the ring.

5. The stylus of the claim 1, wherein the shaft extends substantially parallel to the axis of the ring.

6. The stylus of the claim 1, wherein the stylus is made of elastic material.

7. The stylus of the claim 5, wherein the stylus is made of plastic.

8. The stylus of the claim 1, wherein the shaft forms a friction portion.

9. The stylus of the claim 8, wherein the friction portion comprises a plurality of protrusions formed on one side-surface of the shaft.

10. The stylus of the claim 1, further forming a locating protrusion or depression.

11. An electronic device, comprising:
a main body; and
a stylus which mounted on the main body;
wherein the main body defines a receiving portion which comprises a first groove and a second groove to receive the stylus, and the stylus comprises a ring and a shaft connected to and at a periphery of the ring.

12. The electronic device of the claim 11, wherein the ring defines an opening, and a clapboard is formed in the second groove engaging the opening.

13. The electronic device of the claim 12, wherein an end of the shaft is connected to the ring, away from the opening.

14. The electronic device of the claim 11, wherein the shaft extends substantially parallel to the axis of the ring.

15. The electronic device of the claim 11, wherein the main body has a first sidewall and a second sidewall adjacent to each other, and the first sidewall defines the first groove to receive the shaft of the stylus, and the second sidewall defines the second groove to receive the ring, the first groove communicating with the second groove.

16. The electronic device of the claim 11, wherein one of the stylus and the main body defines a depression, and the other of the stylus and the main body forms a location protrusion to engage the depression.

17. The electronic device of the claim 11, wherein the shaft further forms a friction portion.

18. The electronic device of the claim 11, wherein the stylus is made of elastic material.

19. An electronic device, comprising:
a main body defining a receiving portion; and
a stylus mounted in the receiving portion of the main body, the stylus comprising a shaft and a ring connected to the shaft;
wherein the receiving portion comprises a first groove receiving the shaft and a second groove receiving the ring, the second groove being substantially at a side of the first groove.
